(19) United States
(12) Patent Application Publication
(10) Pub. No.: US 2002/0007459 A1
(43) Pub. Date: Jan. 17, 2002

(54) Method and apparatus for intentional blockage of connectivity

(76) Inventors: Gerard R. Cassista, Dracut, MA (US); Philip A. Cassista, Nashua, NH (US)

Correspondence Address: Philip A. Cassista, Apt. 2F, 106 Vine Street, Nashua, NH, 03060, US

(21) Appl. No.: 09/906,476

(22) Filed: Jul. 16, 2001

Related U.S. Application Data
(60) Provisional application No. 60/218,723, filed on Jul. 17, 2000.

(51) Int. Cl. H04M 1/66

(52) U.S. Cl. 713/200; 709/229; 379/93.02

(57) ABSTRACT

The invention is a device for the controlling or limiting of access to electronic networks, comprising a mechanical lock or other standard access control device (such as a numeric keypad, keylock switch, or biometric sensor), a switchable data connection, and an electronic means for detecting and reporting tampering attempts. Specifically, this method and apparatus is designed to be easy to understand and apply, and it inherently embodies simple but effective barriers to spoofing attempts.

### BACKGROUND OF THE INVENTION

Prior art described hereafter may provide useful context to understand the invention. No claim is made to the trademarks cited herein.

Since the invention of the telephone, and especially since the popular acceptance of the Internet into residential households, there frequently arises a need for limitations on such connectivity. Electronic networks such as PSTN (Public Switched Telephone Network) which can carry analog voice communication as well as digitally transmitted information, Ethernet connections, and fiber optic links are among the myriad network technologies that sometimes are better left disconnected.

The need for such controls is clearly shown by the widespread popularity of such software programs as NetNanny (Net Nanny Software International Inc., Vancouver, B.C.), Cybersitter (Solid Oak Software, Santa Barbara, Calif.), and the commonplace browser feature set known collectively as “parental controls”. Additionally, many websites that are intended for use by children and families identify themselves clearly as “kid-safe”, etc., further demonstrating the popular need for methods of ensuring appropriate use of the Internet and other such uncontrolled electronic communications media.

Unfortunately, the currently available methods of exercising such control tend to rely on software to perform their function, and such software can easily be foiled by today's net-savvy youth. Making matters worse, parents and guardians are frequently naive and unschooled in matters of software security. In many cases children are more effective at side-stepping parental controls and passwords than their parents and guardians are at applying them.

Software programs that monitor Internet usage inherently require that the monitoring user boot up the computer, if it is not already running, in order to verify status. This is a time-consuming step that may tend to discourage adequate monitoring by the authorized user. Additionally, the need to configure and operate software may further daunt the authorized user.

Certainly there have been many parents and guardians who wish that they could simply “pull the plug” on their children's use of the Internet and or telephone, but they know that if they were to remove the connecting cables, the cables could be easily reconnected whenever their back is turned.

Business, schools, and other organizations also need this type of control, such as to limit employee's recreational, personal, or malicious use of electronic networks. Businesses also need to maintain high-security limited access to LAN's that deal with company-sensitive data, etc. Most typical solutions that are in place today, such as dongles and passwords, utilize software in some way. This is clearly a weak link in the security chain.

Malicious computer programmers, sometimes known as “hackers” make a sport and a vocation out of creating ways to defeat the software network protection programs known collectively as “firewalls”. This has become an increasing threat as the popularity of “always-on” Internet connections rises, since this provides hackers with a very large window of opportunity to perform their misdeeds. Their frequent and unabating success at this further points out the need for a mechanical, software-free method of controlling network connectivity.

In both residential and organizational software-based access controls, there is the additional problem that authorized users may not always secure their computer connections for brief periods away from their computers, because the log-off and log-on procedures may be perceived as cumbersome. Clearly, a simple-to-use device would reduce the temptation of carelessness.

The LockJack by General Electric is a special wall plate that incorporates a keylock switch in series with the telephone jack. It is designed to be installed in place of a typical telephone connector wall plate. The authorized user must therefore gain physical access to the wall jack, which is most typically located near the floor, and frequently behind furniture, in order to switch the state of the LockJack. This renders the LockJack a cumbersome system to use. The most important failing of the LockJack system, though, is that it can so easily be foiled. Most residences have multiple telephone jacks in various rooms, as do essentially all businesses and schools. To circumvent the obstacle of a switched-off LockJack, then, all a user has to do is run a readily available telephone extension cable from the computer to the nearest unprotected telephone jack. There is nothing in the LockJack system to prevent or deter this.

If a residence or business were to deploy a sufficient quantity of LockJack wall jacks in place of normal telephone wall jacks to make the system hard to circumvent, the resulting lack of operational telephone jacks could become a danger unto itself. Unknowing persons would see telephones and expect them to be operating units, but they would instead find that they are locked and unusable for dialing 911 for emergency services.

Flowers' U.S. Pat. No. 5,774,543 (1998) describes a telephone wall jack that incorporates an internal keylock switch. Except for details of construction, this invention bears great resemblance to the LockJack device described above, and shares with it all of the limitations and failings of that system.

Hi Q Telecom Inc (Miami, Fla.) manufactures a set of products exemplified by their T-Lock Mini-Box. The T-Lock Mini-Box requires that the authorized user key in a 4-digit security code prior to dialing any telephone numbers that are on the unit's “restricted” list. The manufacturer recommends that a trained technician install the device. Before it can be used, the user or a technician must program the unit, using the keypad of an attached telephone. In addition to the high cost and complexity of the installation, another severe limitation of this system is that the authorized user must know, in advance, which local telephone numbers to block or unblock. Since most Internet service providers provide a large and growing list of local dial-up numbers in each area, it is nearly impossible for the authorized user to effectively restrict access to the Internet using this device. Also, the 4-digit security code can very simply be determined by listening to the tones on an extension phone, as an authorized user is dialing the security code.

Systems of the type exemplified by the T-Lock Mini-Box operate using a microcontroller of some sort, which most typically includes clocked digital logic. Such clocked logic inherently generates electrical noise that can interfere with modem operation and can potentially cause audible noise pickup in telephone systems and computer sound cards that are operating nearby.

Horn U.S. Pat. No. 5,661,786 (1997) describes a system that is only applicable to computers that have internal dial-up modems that are installed as add-in cards. This system comprises a keylock switch connected in-line with the telephone cable. The telephone cable is secured to the computer case by a special shroud that the authorized user must install (or have installed) into the case of their PC-style personal computer. Obviously, since the installation of this system requires the partial disassembly of the user's computer, it is a nontrivial exercise and involves some risk of damaging the computer and/or voiding computer warrantees that require that the case remain unopened by the owner. Such an installation also makes the computer difficult to move or relocate, since the keylock switch box becomes a semi-permanent attached appendage of the computer case.

A second patent issued to Horn, U.S. Pat. No. 5,938,767 (1999) describes a special add-in modem card that incorporates a locking device, such as a keylock switch. The locking device is described as preferably mounted on the front face of the computer body. This system is applicable as a design-in for new computer designs only, and it therefore does not provide a cost-effective or workable solution to objects of the present invention as it relates to the large installed base of pre-existing computer designs that cannot be retrofitted in this way.

Both of the Horn inventions described above share some common weaknesses.

First, they both presuppose that the internal dial-up modem is the only means of accessing the Internet. Typically, this is not truly the case, since most PC's are also equipped with serial ports (com ports), USB connections, and/or PCMCIA card slots. External modems are readily available for each of these port formats. To bypass either of the inventions of Horn, then, an abuser of the system merely needs to connect such an external modem to the unguarded telephone jack at the wall plate and instruct the software to use the external modem instead of the internal one.

Secondly, they both must be actively switched on or off by the authorized user. These systems do not incorporate any timer function that would make them user-friendly in the commonplace situation of limiting the amount of time that a child is allowed access to the Internet. Instead, the authorized user must perform this task manually, first by switching on the system, then (hopefully) remembering to return to switch the system off again.

Blum U.S. Pat. No. 4,647,726 (1987) and McFadden U.S. Pat. No. 5,556,295 (1996) disclose single-use frangible clips for locking modular plugs into their jacks. Both inventions provide protection against casual tampering with the telephone line connection. The object of the Blum invention is to discourage theft of telecommunication devices, while the invention of McFadden is directed to anti-theft use as well as to hinder the disconnection of telephones for convenience, and other non-Internet related uses. The user of such devices would need to frequently and carefully re-inspect the clip installations to gain assurance of system integrity, if used in anything but an anti-theft application. As stated earlier, telephone line connections are typically quite inaccessible for such periodic inspections, so a spate of unauthorized usage would likely continue for a long time before detection. Also, such clips are designed to be non-reusable, which limits the number of times that any system incorporating them can be relocated unless the authorized user can continue to procure replacement clips.

A number of methods have been developed for guarding against the theft of computer systems. This purpose is clearly not an aim of the current invention, but such prior art is discussed herein to allow us to err on the side of over-inclusiveness. Harmon U.S. Pat. No. 5,925,128 (1999) and Glenn U.S. Pat. No. 5,406,261 (1995) describe methods of shutting down a computer, thru interruption of AC power and other means, to disable a computer for use by anyone but an authorized user. Mueller U.S. Pat. No. 5,142,269 (1992) is directed at anti-theft applications and describes a device for computer equipment that sounds an alarm when a protected data cable is removed and/or the alarm system wiring is cut. The system of Mueller fully requires the use of a specialized housing to accept the connectors, making it unsuitable for typical Internet restriction applications, where standardized connectors are pre-existing on commercially available modem equipment. Also, in this and several similar inventions, the alarm is electrically operated and can be defeated by removing the source of power to the alarm circuit. Cummings U.S. Pat. No. 5,406,260 (1995) discloses a method and system for detecting the disconnection of electronic equipment from a network using internal current loops, current sensors and optional alarms. The system includes current loops internally coupled to protected pieces of equipment so that each piece of associated equipment has an associated current loop. A sensor monitors the current flow through each current loop to detect removal of the equipment from the network, which in turn may activate an alarm. The system of Cromer U.S. Pat. No. 6,026,492 (2000) disables the computer when a network communication line is removed.

These and other similar prior art references are not appropriate to the aims of the present invention.

### BRIEF SUMMARY OF THE INVENTION

It is an object of this invention to provide a method and apparatus which corrects the deficiencies of prior art attempts at providing a secure means of limiting access to the Internet and other electronic communications networks.

The device comprises a mechanical lock or other standard access control device (such as a numeric keypad, keylock switch, or biometric sensor), a switchable data connection, and an electronic means for detecting and reporting tampering attempts.

Specifically, this method and apparatus is designed to be easy to understand and apply, and it inherently embodies simple but effective barriers to spoofing attempts.

It is an object of the present invention to provide a lockout system in which the device tampering status can be visually checked without the need to boot up or operate a computer, which promotes simplicity and speed of use.

It is an object of the present invention to provide a lockout system using low cost technologies and materials so that the device can be made to fit the budget of families with limited funds.

It is an object of the present invention to provide a lockout system that can be easily installed and operated by an authorized user without any special skills or training.

It is an object of the present invention to provide a lockout system that maintains a record of tampering attempts even if it's source of power is naturally or maliciously cut off.

It is an object of the present invention to provide a lockout system that can be bypassed by anyone in an emergency, thereby not interfering with 911 dialing, etc.

It is an object of the present invention to provide a lockout system that monitors the integrity of both the modem end and the wall end of a communication cable, so that the system cannot be easily thwarted by connecting an external modem between the wall connection and an IO port of the computer.

It is an object of the present invention to provide a lockout system that can be configured using non-clocked electronics so as not to generate electrical noise that can degrade modem operation and create noise in audio hardware of a computer system.

It is an object of the present invention to provide a lockout system that can be installed and removed from a computer without requiring modifications that could jeopardize the resale value or warrantee status of the computer.

It is an object of the present invention to provide a lockout system that can be configured to include a timer function whereby an authorized user can permit temporary use of the system by a non-authorized user for a predetermined length of time.

It is an object of the present invention to provide a lockout system that does not rely upon application-specific non-reusable hardware, such as frangible locking mechanisms, so that it can be simply and economically transferred from system to system, as desired by the authorized user.

It is an object of the present invention to provide a lockout system that does not use or require software or programming, and that can be used or easily adapted to any computer platform that is connected in some way to any network.

It is an object of the present invention to provide a lockout system that is effective at both limiting access to networks by unauthorized users who are present at the site of the lockout system installation, as well as limiting the access that malicious off-site hackers can have to a networked computer.

Still other objects and advantages of the present invention will become readily apparent to those skilled in this art from the following detailed description, wherein we have shown and described only the preferred embodiments of the invention, simply by way of illustration of the best mode contemplated by us for carrying out the invention.

### BRIEF DESCRIPTION OF THE SEVERAL VIEWS OF THE DRAWINGS

FIG. 1A is a diagram of the components of a preferred embodiment, with the telephone line interface box connected

FIG. 1B is a diagram of an alternative interface box

FIG. 2 is a diagram of a telephone line interface box within the preferred embodiment of FIG. 1

FIG. 3 is a diagram of the lock box within the preferred embodiment of FIG. 1

FIG. 4 is a schematic of a latching relay driver that can be used as the electronic switch circuit within the preferred embodiment of FIG. 1

FIG. 5 is a schematic of a LED and pushbutton interface that can be used in the preferred embodiment of FIG. 1

FIG. 6 is a schematic of a tamper detect threshold and latching circuit that can be used in the preferred embodiment of FIG. 1

FIG. 7 is a schematic of a passive voltage sampling circuit

FIG. 8 is a schematic of an alternative voltage sampling circuit with an active buffer

FIG. 9 is a touch sensing circuit that is useful in some embodiments

FIG. 10 is an embodiment based on the use of a keypad

FIG. 11 is a flow chart pertaining to the embodiment of FIG. 10

FIG. 12 is a diagram of an RJ plug with external tamper-detecting conductive elements

FIG. 13 is a diagram of an RJ plug with internal tamper-detecting conductive elements

### DETAILED DESCRIPTION OF THE INVENTION

The invention is capable of many embodiments. The following are preferred embodiments.

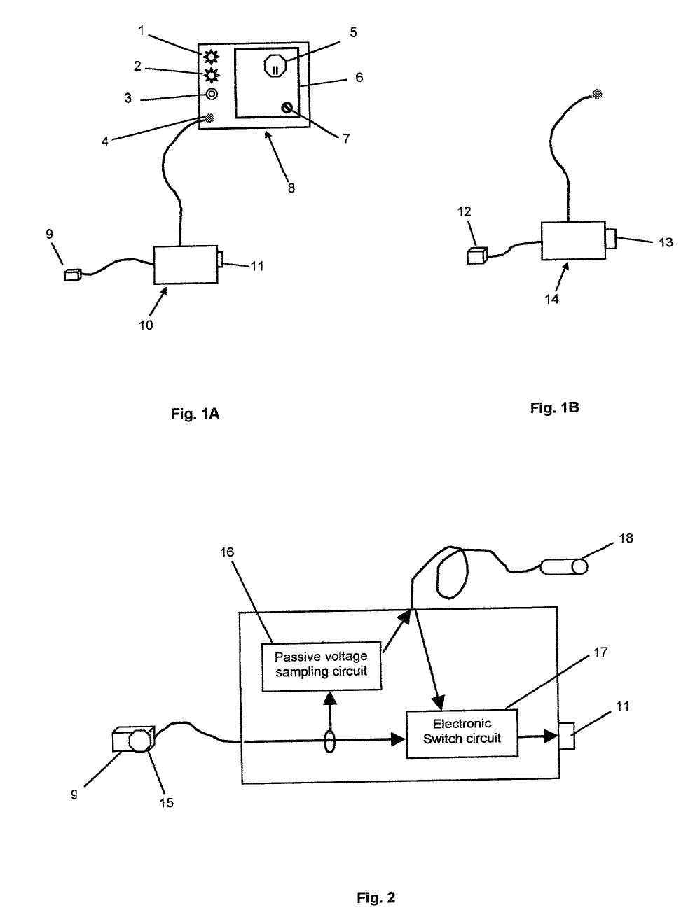

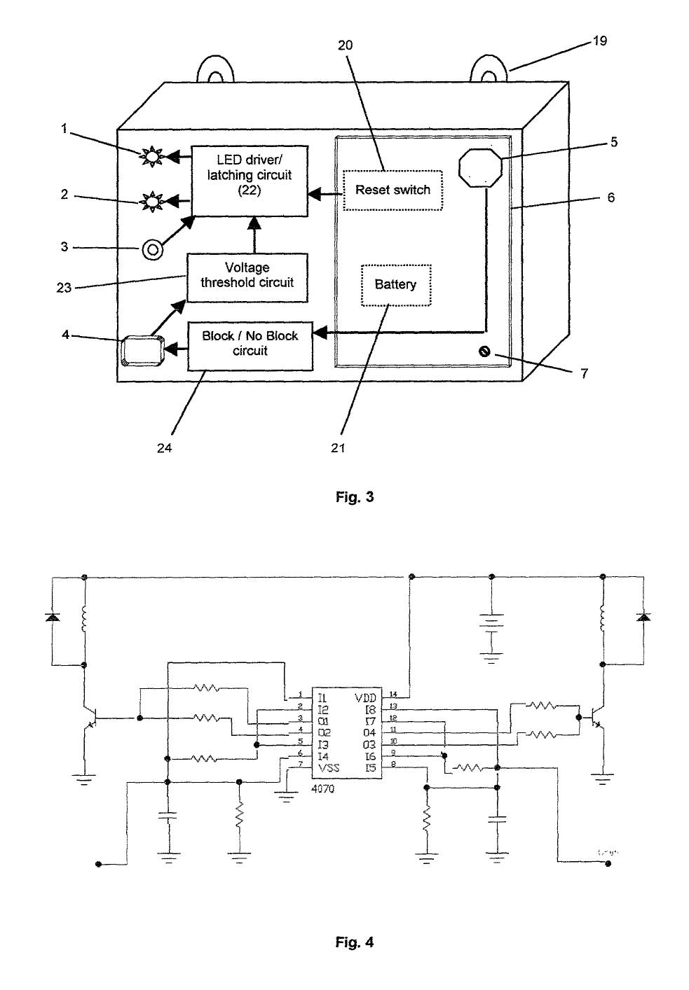

FIG. 1 is a block diagram of the components of the preferred embodiment showing a lock box (8) and two different varieties of interface boxes (10 and 14). Details of these functional blocks are described in FIGS. 2 and 3.

FIG. 2 is a block diagram of a telephone line interface box (10) within the preferred embodiment. The female RJ-11 phone jack (11) of the interface box is connected to the Internet connection cable (not shown), and the male RJ-11 phone plug (9) is connected to the modem (not shown) within the user's computer or other internet-enabled device. The interface box shown has locking hardware (15) to frustrate attempts at tampering with this interface box-to-modem connection. A passive voltage sampling circuit (16) is connected to the incoming data cable, producing a predetermined DC output voltage level in the presence of a valid connection to the incoming data transmission cable or telephone line. An electronic switch circuit (17) is used to operably connect the two RJ-11 connectors to each other when an appropriate signal is received through the interface box-to-lock box plug (18). In the absence of this appropriate signal, the electronic switch operably disconnects the two RJ-11 connectors from each other.

FIG. 3 shows a block diagram of the lock box within the preferred embodiment. This lock box has a keylock switch (5) that is arranged to hold the access cover (6) in place when in the locked position. With the lock in the locked position there is a contact closure that is used as a controlling signal applied to the block/no block circuit (24). With the lock in the unlocked position the access cover can be removed by manipulation of the cover hold-down (7), exposing the battery (21) and a reset switch (20). Mounting hardware (19) on the lock box facilitates mounting the lockbox for easy accessibility by the user. Within the lock box there is a voltage threshold circuit (16) that monitors the DC voltage from the telephone line interface box. This circuit connects to an LED driver latching circuit (22) which is in turn connected to the Battery LED (1), the Tamper LED (2), and a pushbutton (3) on the surface of the lock box. The reset switch (20) allows the LED driver/latching circuit to be reset by the key owner. The block/no block circuit provides an appropriate output signal to the interface box to command the contact closure status of the electronic switch circuit.

List of Numbered Components

1. Battery LED

2. Tamper LED

3. Pushbutton

4. Interface box-to-lock box socket

5. Keylock switch

6. Access cover

7. Cover hold-down

8. Lock box

9. Male RJ-11 phone plug

10. Telephone line interface box

11. Female RJ-11 phone jack

12. Male RJ-45 plug

13. Female RJ-45 jack

14. Ethernet interface box

15. Locking hardware

16. Passive voltage sampling circuit

17. Electronic switch circuit

18. Interface box-to-lock box plug

19. Mounting hardware

20. Reset switch

21. Battery

22. LED driver/latching circuit

23. Voltage threshold circuit

24. Block/No Block circuit

28. Moving contactor

29. Fixed contactor

30. Multiconductor cable

36. Red LED

37. Yellow LED

38. Green LED

39. Orange LED

40. Timer circuit

41. Keypad

42. Keypad interface circuit

43. Tamper-evident tape

44. Latching relay

45. RJ connector to network

46. RJ connector to modem

47. Dual passive voltage sampling circuit

48. LED interface circuit

49. Housing

50. thru 81. Flow chart symbols (FIG. 11)

Operation

A preferred embodiment of the access control device of the present invention is illustrated in FIG. 1, which demonstrates many of the features with which the present invention may be endowed.

The lock box (8) has mounting hardware (19) that allows it to be mounted in a convenient location for operation of the keylock switch (5) by an authorized user. An interface box, such as the telephone line interface box (10) or the Ethernet interface box (14), is connected in-line with the data cable to the computer or similar device. This interface box can be mounted in a nonaccessible location (such as near the back of the computer) since the operator will not normally need to deal with it once the device is initially connected. In this example of the preferred embodiment we will refer to the detailed view of the telephone line interface box (FIG. 2) with the understanding that the Ethernet interface box (14) operates in a very similar manner. Unless the keylock switch of the lock box is rotated to it's “on” position, thereby commanding the block/no-block circuit (24) to enter the no-block state, the electronic switch circuit (17), which can be a relay or other switchable electronic circuit, is commanded to an “off” state in which the electrical connection of the data path between the RJ connectors is intentionally blocked.

Unauthorized users may attempt to circumvent this obstacle by removing the interface box from the data path and simply reconnecting the data cable without the interface box. The preferred embodiment shows locking hardware (15) on the male RJ-11 phone jack (9) to thwart casual abusers. As a more effective control on this type of unauthorized tampering, the interface box is equipped with a passive voltage sampling circuit (16) which sends a signal to the electronics within the lock box whenever the interface box is disconnected from the telephone line. The lock box is shown in greater detail in FIG. 3. It can be seen that the lock box contains a voltage sensing circuit (23) which monitors the output of the passive voltage sampling circuit and, thru the function of the LED driver/latching circuit (22), provides a latched electronic record of any sensed disconnects of the interface box from the telephone line. The authorized user can query the tampering status of the system by pushing the pushbutton (3). This pushbutton actuation causes the LED driver/latching circuit to momentarily illuminate the battery LED (1) as a proof of system functionality. If there has been a tampering attempt (as detected by a gap in the output of the passive voltage sensing circuit), then the tamper LED (2) will also momentarily be illuminated by the LED driver/latching circuit. If there has been no tampering, only the battery LED will light. This tamper detection and reporting is intended to inhibit tampering by unauthorized users.

Alternative visible display devices and audio options exist to replace or augment the LED-based tamper reporting means shown in the preferred embodiment. For example, an LCD display or an audible alarm could provide additional benefits in certain applications. A real-time clock can be used to provide a date and time of day of any tampering, for example, and an audible alarm could alert the authorized user in a speedy fashion.

The keylock switch of the preferred embodiment also performs the secondary function of mechanically securing the lockbox door in the closed condition when it is in the “off” position. To reset the latched electronic record of tampering, an authorized user of the system must both actuate the keylock and manipulate the cover hold-down (7) to open the access cover and push the reset switch (20). The authorized user can also thereby access the battery (21) for replacement as necessary. A mechanical or electronic timer (not shown), with controls that are covered by this access cover, can also be adjusted or set by authorized users, in embodiments including such an option. Such a timer can be arranged to allow connectivity to the network for a predetermined period of time. A similar option would be the inclusion of an access-limited real-time clock, which would allow authorized users to set “on” and/or “off” conditions to occur at certain programmable times.

The authorized users of the system therefore have the exclusive ability to control access to the data, and to reset the tamper detection circuit as required, because they possess appropriate keys to the keylock switch.

If a potential abuser attempts to break or modify the connection of the interface box to the interface box-to-lock box socket (4), the system would register the gap in the output of the passive voltage sampling circuit as a tampering attempt. Furthermore, the particular circuits that are shown in FIGS. 4 thru 9 are designed to foil attempts at surreptitiously deactivating the circuit. FIG. 4 shows a latching relay driver that can be used as the electronic switch circuit of an interface box. This circuit has two signal inputs that travel from the lock box to the interface box. To disrupt the data connection, a logic high (nominally +9V) must be applied to the “Open” signal wire while there is no voltage applied to the “Close” signal wire. Conversely, to allow the data connection, a logic high (nominally +9V) must be applied to the “Close” signal wire while there is no voltage applied to the “Open” signal wire. The circuit applies power to the relay coils only long enough to cause relay actuation, to conserve battery power. The latching relays in the interface box (only the coil windings are shown in the schematic of FIG. 4) remain indefinitely in whatever state to which they were last commanded. By using a circuit such as that shown in FIG. 4, a potential abuser would gain nothing by sabotaging the connection of the interface box to the lock box, and the attempt would also register as a tampering event.

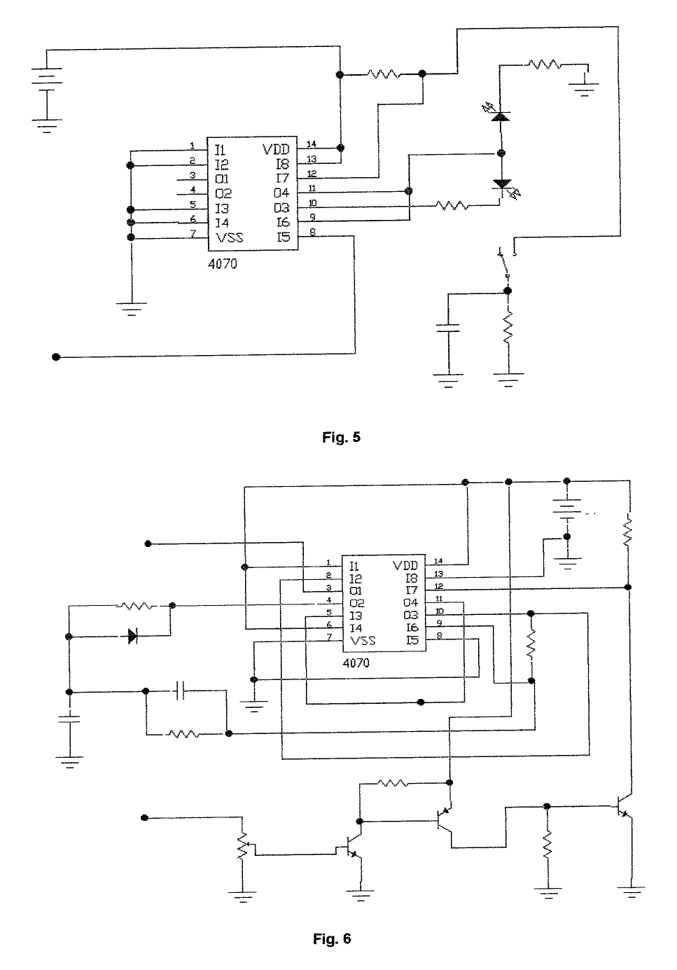

The circuit of FIG. 5 is a LED and pushbutton interface circuit that is designed to be simple to operate, use minimal battery power, and thwart abusers. Specifically, the circuit is simple to operate because it provides a clear indication of two types of status (battery health and tampering history) with only one pushbutton. The fact that it provides only momentary LED illumination has the double benefit of conserving battery power and making it very difficult for an abuser to “kill” the battery (thereby attempting to mask any tampering attempts) by simply holding the battery test pushbutton in the “test” position.

The circuit of FIG. 6 is a tamper detect threshold and latching circuit that is designed around a single generic logic IC, for simplicity. The three-transistor circuit provides a high gain path that results in a logic “1” in the absence of a proper signal level at it's input. The diode, resistors, and capacitors cause the 4070 logic gate to latch a when a logic “1”, indicating a tampering event, is detected. The reset pushbutton is used to clear this flag.

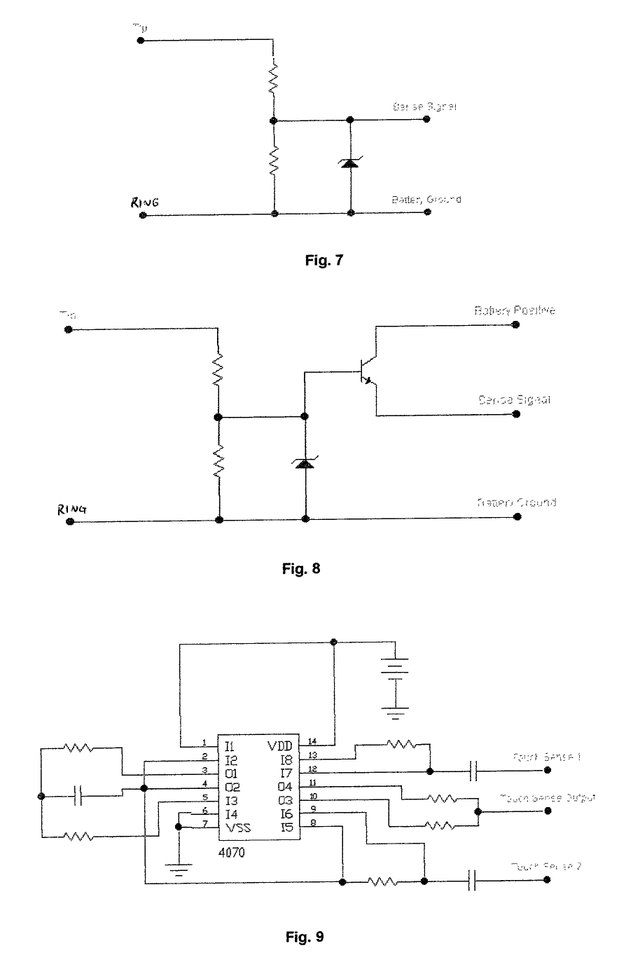

FIG. 7 shows a simple passive voltage sampling circuit for use with telephone lines. The resistive divider produces a nominal 4.8V DC level when connected to an energized “on-hook” telephone line. This level may drop to about 2V DC when the modem is “off-hook”. The only time that the DC level will drop to zero is when the circuit is removed from the telephone line. The zener diode limits the output voltage to protect against ESD transients and telephone ring voltages. Circuit values are chosen to present at least 10 Megohms impedance to the telephone lines in accordance with typical telephone exchange “on-hook” impedance requirements.

FIG. 8 shows the circuit of FIG. 7, with the addition of an active buffer transistor to lower the output impedance of the sampling circuit. This can be a useful addition in electrically noisy environments where the output impedance of the unbuffered divider (about 1 Megohm) could allow false tamper signals to be generated due to susceptibility of the high impedance line to EMI, etc.

Note that the lower resistor in the resistive dividers of FIGS. 7 and 8 can be replaced by a series combination that can include one or more diode junctions and a resistor. In this way, the wide dynamic range of the signal being measured (anywhere from +100V to +3V is to be expected) can be compressed by the logarithmic transfer function of the diode junctions.

Tamper detection in Ethernet systems is even simpler, since the differential signals in both the TX and RX lines provide relatively low impedance signals with a narrow dynamic range. One method of Ethernet tamper detection would employ a resistor in series with the LED of a low-current optocoupler, connected between the differential signal lines of either the TX or RX pair. The presence of a delta voltage will forward bias the LED and switch the optocoupler into conduction. By connecting a second optocoupler LED in reverse orientation to the first, and by OR-tying the phototransistor collectors together, the output of the complete circuit will be conducting as long as the monitored wire pair remains connected to the network.

FIG. 9 shows a touch sensing circuit that detects excess capacitive loading (relative to a predetermined threshold level set in the threshold circuit of FIG. 6) on either of the “Touch Sense” nodes. This circuit can be used as a tamper detector in several ways. First, in systems where the data path is by optical fiber, there is no voltage that can be sensed, as by a circuit such as shown in FIGS. 7 and 8. In such cases, this touch sensing circuit can monitor the capacitance of a metallic sleeve that can be arranged to be permanently bonded to the outside of the fiber cable. If an abuser tries to remove the optical fiber, the change in capacitance provides a tamper-sensitive signal to the system. This circuit can also be used in USB and Ethernet data links, with appropriate bandstop filtering on the sense lines, to continuously monitor the capacitance of the data lines that are connected to the interface-box. Removal of either or both data connectors would reduce the capacitance and result in a tamper signal.

The circuits of FIGS. 4, 5, 6, and 9 all make use of the CMOS 4070 quad exclusive-or logic gate. This should not be construed as a limitation of the invention to this particular IC. The repetitious use of the same IC type is done to keep the parts list for the preferred embodiment to a minimum, while still demonstrating various important concepts of the invention. Obviously, a wide range of alternative circuit implementations exists to perform the electronic functions described herein.

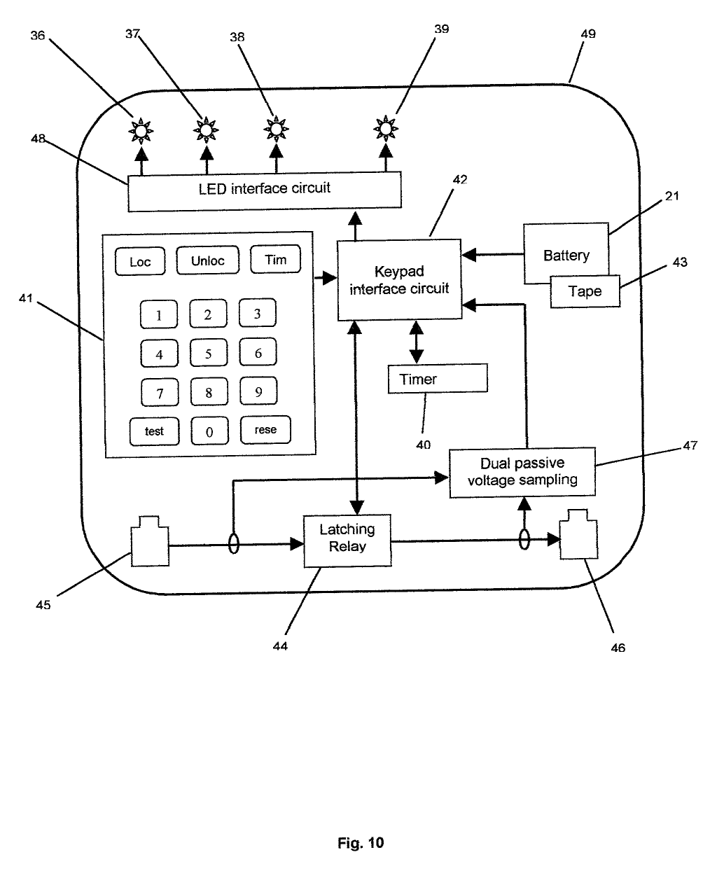

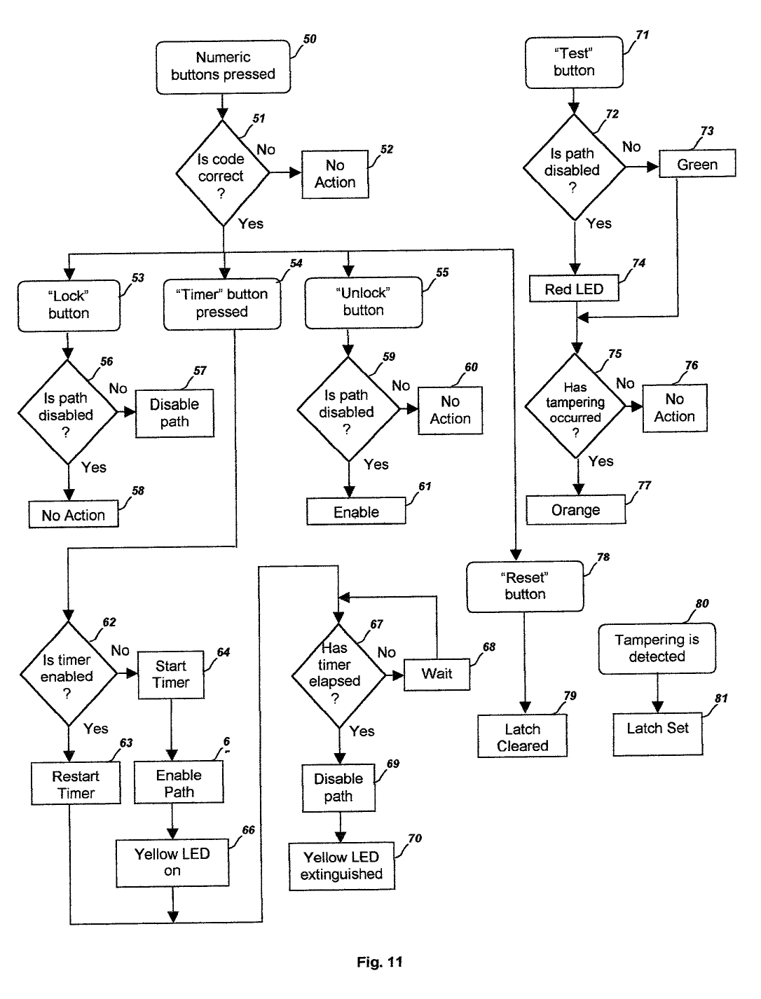

The embodiment of FIG. 10 uses a keypad (41) and keypad interface circuit (42), which incorporates a circuit to implement a keypad sequence code, to limit certain control functions to authorized users. Within the tamper-resistant housing (49) is also a timer (40) which can be used to cause the effectivity of control functions (usually the “lock” command to disable the connectivity path) to occur at predetermined times or after a predetermined delay time. A battery (21) is used to supply power to the unit as necessary, and it is shown covered with a tamper-evident piece of tape (21) that can be used to discourage tampering with the battery connection by abusers of the system. The dual passive voltage sampling circuit (47) simultaneously monitors the network connection tamper status on both sides of the latching relay (44). This dual-sensing feature is preferred, so that the system cannot be easily thwarted by connecting an external modem between the wall connection and an I/O port of the computer. To do this will typically require that the wall jack be made available to the external modem by removing that end of the cable, and with the dual-sensing feature, tampering with either end of the thru path, even while the relay is in the open circuit condition and the path is disabled, will be detected. In more advanced embodiments, there can optionally be an additional temper-detection circuit which monitors the waveforms on the telephone line and detects the presence of modem tones on the line. This would be indicative of a second modem being used, possibly by an unauthorized user attempting to circumvent the restriction on the line by connecting the second modem into an unprotected port of the computer. This detector can be implemented using digital, analog, or mixed-signal circuitry and would be capable of identifying modem tones as non-speech signals. This can be accomplished most easily by identifying the presence of pauses that are found in human speech, or conversely, the relative lack of pauses in modem tones. It would be up to the authorized user to verify that such an “modem detection” feature would be a suitable option in a particular installation of the device, or whether this option should be disabled in those installations where the presence of multiple legitimate modems on a single network line could cause false positive indications of tampering. Similarly, the presence of an operating fax machine on a monitored telephone line could give false positive indications of tampering, depending on the level of sophistication of the modem detection circuit.

The output of the dual passive voltage sampling circuit connects to the keypad interface circuit, which preferably has a latching circuit to store the occurrence of any tampering events. In such embodiments, an additional control function which would typically be limited to authorized users would be the reset function, whereby the authorized user can clear the latching circuit or relay back to the “untamper” condition as needed.

In applications where an audible alarm or visible display device is used as a means for reporting tampering attempts, a loudly audible and/or highly visible alarm output could be relied upon as a sufficient deterrent so that no follow-up capability, such as a latching circuit, is necessary.

The keypad interface circuit (42) also provides outputs to the LED interface circuit (48). This circuit controls the illumination status of a red LED (36) that indicates a “disabled path” condition (latching relay is open), a yellow LED (37) that indicates that a timer function is being exercised, a green LED (38) that indicates an “enabled path” condition (latching relay is closed), and an orange LED (39) which is a visible display device which is used for reporting tampering attempts.

The latching relay shown in the embodiment of FIG. 10 preferably provides at least a DPST (Double-Pole, Single Throw) functionality. It provides two functions. First, one pole of the relay is used as a device for inhibiting the connection to the analog or digital network by electrically disconnecting a conductive path between the two connectors, by which means it enables or disables a connection path in line with the network. It's second function is not perhaps as obvious. That second function is to serve as a sort of memory, or nonvolatile latching circuit element, which retains the last state to which it was commanded, even in the absence of power. In this way, some embodiments of this invention minimize battery usage by operating for prolonged periods without needing to draw power supply current to maintain a continuous “locked” or “unlocked” state. The second pole of the relay can be included in a “test” circuit, whereby the user can verify the state of the path. Such a test circuit can be as simple as a pushbutton, a resistor, a source of power, and an LED in series with the second pole of the relay.

Similarly, and to keep the parts list short, a latching relay can be used as a latching circuit element to retain data on the tampering status of the device, even in the absence of power for indefinite periods of time. This can be done by arranging the tamper-detecting circuit to command this latching circuit into a state which signifies “tamper event has occurred” whenever such an event occurs. The authorized user would then be capable of clearing this status flag by performing some reset function, such as depressing an access-limited pushbutton, for example.

As solid-state alternatives to the latching relay of the preferred embodiments, there now exist a variety of components that provide nonvolatile latching circuit memory functions. For example, the DS1809 Dallastat by Dallas-Maxim (Dallas, Tex.) is a single 64-position digital potentiometer in which the wiper position is maintained, in the absence of power, in EEPROM. This device automatically stores it's last state in EEPROM as it detects a power-down situation, and it automatically sets itself to this state upon power supply reinstatement. With a small number of additional components, one skilled in the art could easily configure this device as a latching circuit for inclusion in an embodiment of the present invention. A similar function can be achieved by using a Ferroelectric RAM-based device, such as the FM573 from Ramtron International Corporation (Colorado Springs, Colo.). These devices function as standard TTL latches when power is applied. When a power-down event occurs, the state of the logic device is stored in FRAM. The last logic state is retained for an indefinite period in the absence of power, and it is automatically restored to the logic device upon power supply reinstatement.

Turning now to FIG. 11, the flowchart illustrates one possible scenario for the embodiment of the invention disclosed in FIG. 10. In step (50) the numeric buttons of the keypad are used to provide a code, typically of four or five digits in length, that is compared with a pre-set code (51). If the digits entered are invalid, the device takes no action (52). If the code entered is correct, the authorized user is then capable of selecting either of three control functions, which are “lock” (53), “timer” (54), and “unlock” (55). If the authorized user selects “lock” and the path is not already disabled, as shown in block (56), the path is then disabled (57). If the path was already disabled, the device takes no action (58). If instead of selecting the “lock” button, the “timer” button is pressed (54), the device starts the timer (64), enables the path (65), and continuously illuminates the yellow LED (66) for the duration of the timer setting (67 and 68). If the timer was already started at the point of block 62, the device merely resets the timer to zero by restarting the timer (63), effectively lengthening the duration of the timer by a full timer setting. If instead of either selecting “lock” or “timer”, the authorized user selects “unlock” and the path is already disabled, as shown in block (59), the path is then enabled (61). If the path was not already disabled, the device takes no action (60). If instead of either selecting “lock”, “timer”, or “unlock, the authorized user selects “Reset” (78) the latch is cleared (79). This action will reset the latched indication of a tampering attempt to a cleared state.

If tampering is detected by the device (80), the latch is set (81). The latched record of tampering may optionally trigger a latched alarm which would need to be reset by an authorized user.

The “test” button (71) is accessible to both authorized and unauthorized users, in this scenario. When it is pressed, the device checks whether the path is disabled (72). If it is disabled, the red led is flashed momentarily (74). If the path is not disabled, the green LED flashes momentarily instead (73). A further result of pressing the “test” button is that the device checks whether a tampering event has been recorded (75). If one has, the orange LED is flashed momentarily (77), otherwise, the device takes no action (76).

An option that can easily be added to the keypad-based embodiment is an ultracapacitor and support circuitry to provide back-up for a removed or drained battery. Similar energy storage devices are also known as ultracapacitors, supercapacitors, or Electrochemical Double-Layer Capacitors (EDLC). These long-lifetime devices are growing in popularity as energy storage devices in battery back-up applications. An abuser of the system might reason that removal of the battery would eliminate the device's ability to detect and/or latch a flag to indicate tampering. Following the misuse of the system in this way, the system abuser would expect to replace the battery with impunity. The ultracapacitor back-up option would thwart this. With the battery removed, the device would preferably disable any LED operation or other battery-draining functions, so that the device would still be able to detect and store tampering events for hours or days in this mode. When a fresh battery is inserted, any tempering events so recorded would be displayed using the normal LED functions of the device. NiCd batteries are an additional alternative back-up power source. In systems without ultracapacitor or NiCd battery back-up, tamper evident tape across the battery access door still provides some measure of assurance.

Analog circuits, as opposed to digital logic circuits, can be used in the keypad interface circuit, the timer, the latching circuit and generally everywhere throughout the device. Such analog circuits are generally known in the art but have been somewhat superseded by digital circuits that perform similar functions. The benefit of using non-clocked electronics is to avoid generating electrical noise that can degrade modem operation and create noise in audio hardware of a computer system. In addition, non-clocked circuitry is not subject to many of the regulatory restrictions and certification requirements that accompany the use of clocked logic gates.

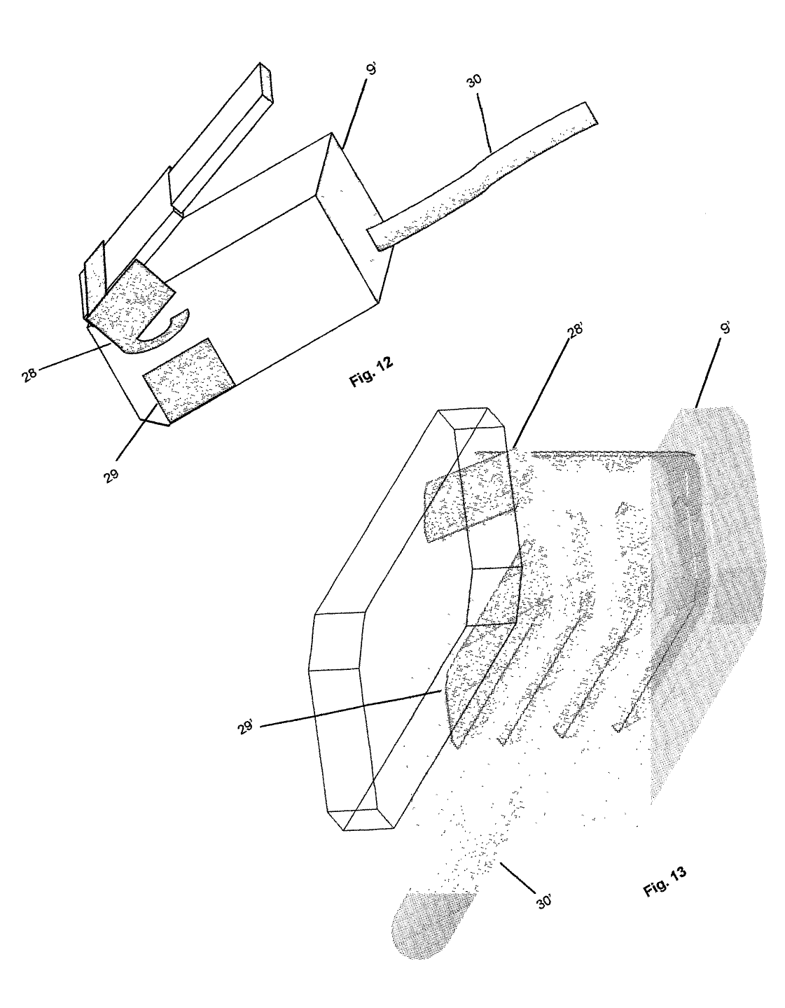

FIG. 12 shows an RJ-11 plug with external tamper-detecting conductive elements. The moving contactor (28) is shown with a projecting resilient finger that will make electrical contact with the fixed contactor (29) whenever the RJ connector tab is depressed, as it must be whenever the connector is removed from or inserted into a female jack. Since typical telephone line modems only make use of the two central conductors of the connector (Tip and Ring), the remaining two conductors that typically exist in the multiconductor cable (30) used in home telephone installations can be connected to the fixed and moving contactors. The external conductive elements can be etched or punched from a thin sheet of resilient metal, as a single unit. After the shroud is formed by bending operations and affixed to a slightly modified RJ plug, the two elements of the contactor assembly (the fixed and moving contactors) can be separated with a knife or micro saw. By this means, the fixed and moving contactor faces can be assured to be in good alignment following installation. This design and assembly methodology, with slight modifications, can be used on all tang-based RJ connector styles, such as the RJ-45 connector that is used with 10BaseT systems.

FIG. 13 shows an RJ-11 plug with internal tamper-detecting conductive elements. This drawing shows a laminated form of construction, but the general concept is also adaptable to RJ-style jacks created by more typical molding operations. In this concept, the nonconductive lamination sheets protect the moving contactor from contamination and handling abuse. The spring tab can optionally be directly formed from the resilient metal sheet that also forms the moving contactor.

The tamper-sensing connectors shown in FIG. 11 and 12 are useful in that they allow the tamper sensing and latching circuit to be simpler, since the measured parameter is a simple contact closure that is electrically isolated from the POTS line voltages and transients. This isolation also simplifies or eliminates the need for compliance testing relative to FCC Part 68 regulations for telephone-line equipment.

Other tamper-sensing connectors can be considered, for example wherein a downwards-pointed U-shaped wire is attached to the spring tab, and the tamper-detect wires (typically conductors 1 and 4 in an RJ-11 plug, for example) are attached to embedded contact plates within the body of the plug. These contact plates are arranged so that the U-shaped wire will electrically connect the tamper-detect wires to each other when the spring tab is pushed down.

Another alternative tamper-sensing connector design would incorporate a resistive strain gage or piezoelectric element, connected permanently between the tamper-detect wires, into the spring tab design. This would provide an electrical signal (change of resistance or a piezoelectrically generated voltage) when the spring tab is pushed down, and this would function as a signal that tampering is occurring. Note that many plastics have piezoelectric properties, which could permit simple implementation of such sensing.

### CONCLUSION, RAMIFICATIONS, AND SCOPE OF THE INVENTION

Thus the reader will see that the access control device of the present invention provides a simple, low-cost, and highly effective solution to the problems associated with previous methods of dealing with this need.

While the above description contains many specificities, these should not be construed as limitations on the scope of the invention, but rather as exemplification of some embodiments thereof. Many other variations are possible. For example, in the electronic versions of the invention, power can be drawn from the data cable itself or from a solar cell on the face of the lockbox, eliminating the need for a battery and potentially also eliminating the access cover and it's associated hardware. Also, FET's and optocouplers can be used in the electronic switch circuit, either separately or in conjunction, in place of the latching relays that are mentioned herein. Also, the keylock switch or the keypad of the embodiments shown can readily be replaced by a magnetic strip card reader, a smart card interface, or any other access-limiting device available to one skilled in this art.

Accordingly, the scope of the invention should not be determined by the embodiments illustrated, but by the appended claims and their legal equivalents.

What is claimed is:

1. An apparatus for controllably inhibiting connection to a network, comprising
a) a means for limiting certain control functions to authorized users,
b) a device for inhibiting said connection to said network based on inputs made by said authorized users, and
c) a means for electronically detecting and reporting tampering attempts.

2. The apparatus of claim 1 wherein the means for limiting certain control functions to authorized users is a keylock switch.

3. The apparatus of claim 1 wherein the means for limiting certain control functions to authorized users is a keypad.

4. The apparatus of claim 1 wherein the means for limiting certain control functions to authorized users is an access-limiting card reader.

5. The apparatus of claim 1 wherein the means for limiting certain control functions to authorized users is a biometric sensor.

6. The apparatus of claim 1 wherein the device for inhibiting said connection to said network is a relay.

7. The apparatus of claim 1 wherein the device for inhibiting said connection to said network is a switchable electronic circuit.

8. The apparatus of claim 1 wherein the means for detecting tampering attempts is a voltage sampler.

9. The apparatus of claim 1 wherein the means for detecting tampering attempts is a touch-sensing circuit.

10. The apparatus of claim 1 wherein the means for detecting tampering attempts is a mechanical switch mechanism.

11. The apparatus of claim 1 wherein the means for detecting tampering attempts is a strain gage mechanism.

12. The apparatus of claim 1 wherein the means for detecting tampering attempts is a piezoelectric mechanism.

13. The apparatus of claim 1 wherein the means for reporting tampering attempts includes a latching circuit.

14. The apparatus of claim 1 wherein the means for reporting tampering attempts includes a latching relay.

15. The apparatus of claim 1 wherein the means for reporting tampering attempts includes a visible display device.

16. The apparatus of claim 1 wherein the means for reporting tampering attempts includes an audible alarm device.

17. The apparatus of claim 1 further comprising a clock operably connected to said device for inhibiting said connection to said network, whereby the effectivity of said certain control functions may be arranged to occur at predetermined times.

18. The apparatus of claim 1 further comprising a timer operably connected to said device for inhibiting said connection to said network, whereby the effectivity of said certain control functions may be arranged to be delayed for a predetermined time.

19. The apparatus of claim 1 further comprising a means whereby authorized users may reset the latched indication of a tampering attempt to a cleared state.

20. The apparatus of claim 1 in which the means for detecting tampering attempts comprises a detector for identifying modem tones.

21. The apparatus of claim 1 further comprising a back-up power source.

22. An apparatus for controllably inhibiting connection to a network, comprising
a) a keypad for limiting certain control functions to authorized users by use of a keypad sequence code,
b) a relay to enable or disable a connection path in line with said network based on inputs made by said authorized users, and
c) an electronic circuit for detecting the removal of the apparatus from the network.

23. The apparatus of claim 22, further comprising a latched alarm.

24. The apparatus of claim 22, further comprising a delay timer whereby the connection path may be arranged to be enabled or disabled for one or more predetermined lengths of time.

25. The apparatus of claim 22, further comprising a clock whereby the connection path may be arranged to be enabled or disabled at one or more predetermined times.

26. A method of controllably inhibiting connection to a network comprising the steps of
a) limiting certain control functions to authorized users,
b) controllably inhibiting said connection to said network based on actions or inputs made by said authorized users, and
c) electronically detecting and reporting tampering attempts.
